(19) United States
(12) Patent Application Publication
(10) Pub. No.: US 2026/0229678 A1
(43) Pub. Date: Aug. 6, 2026

(54) CELL STACK SUPPORT FOR TRACTION BATTERY PACK

(71) Applicant: Ford Global Technologies, LLC, Dearborn, MI (US)

(72) Inventors: Xiaogang Zhang, Novi, MI (US); Jie Deng, Novi, MI (US); Steven T. Wooldridge, Manchester, MI (US); Adam Denlinger, Saline, MI (US)

(21) Appl. No.: 19/042,331

(22) Filed: Jan. 31, 2025

(51) Int. Cl. H01M 50/291; B60L 50/64; H01M 10/613; H01M 10/625; H01M 10/647; H01M 10/6568; H01M 50/211; H01M 50/249; H01M 50/271; H01M 50/293; H01M 50/358

(52) U.S. Cl. CPC H01M 50/291; B60L 50/64; H01M 10/613; H01M 10/625; H01M 10/647; H01M 10/6568; H01M 50/211; H01M 50/249; H01M 50/271; H01M 50/293; H01M 50/358; H01M 2220/20

(57) ABSTRACT

A traction battery pack assembly includes an enclosure assembly and a cell stack within an interior of the enclosure assembly. The cell stack has one or more battery cells. The assembly further includes a corrugated support spanning between the cell stack and an area of the enclosure assembly. The corrugated support supports the cell stack at a position spaced from the enclosure assembly. The one or more battery cells are configured to vent to an area between the corrugated support and the enclosure assembly.

### TECHNICAL FIELD

This disclosure details exemplary assemblies and methods that shield areas of a traction battery pack and, more particularly, to shielding those areas from vent byproducts released from one or more battery cells.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

In some aspects, the techniques described herein relate to a traction battery pack assembly, including: an enclosure assembly; a cell stack within an interior of the enclosure assembly, the cell stack having one or more battery cells; and a corrugated support spanning between the cell stack and an area of the enclosure assembly, the corrugated support supporting the cell stack at a position spaced from the enclosure assembly, the one or more battery cells configured to vent to an area between the corrugated support and the enclosure assembly.

In some aspects, the techniques described herein relate to a traction battery pack assembly, wherein the corrugated support is a metal or a metal alloy.

In some aspects, the techniques described herein relate to a traction battery pack assembly, wherein the corrugated support supports the cell stack.

In some aspects, the techniques described herein relate to a traction battery pack assembly, wherein the corrugated support supports the cell stack at a position spaced from the enclosure assembly to establishes at least one immersion coolant channel between the one or more battery cells and the enclosure assembly.

In some aspects, the techniques described herein relate to a traction battery pack assembly, further including a liquid coolant within the at least one immersion coolant channel.

In some aspects, the techniques described herein relate to a traction battery pack assembly, wherein the one or more battery cells are one or more pouch-style battery cells.

In some aspects, the techniques described herein relate to a traction battery pack assembly, wherein the corrugated support is a first corrugated support that is above the cell stack, and further including a second corrugated support that is beneath the cell stack.

In some aspects, the techniques described herein relate to a traction battery pack assembly, wherein the corrugated support directly contacts the one or more battery cells of the cell stack.

In some aspects, the techniques described herein relate to a traction battery pack assembly, wherein the corrugated support includes a plurality of apertures, each of the apertures in the plurality of apertures receiving a portion of at least one battery cell within the one or more battery cells.

In some aspects, the techniques described herein relate to a traction battery pack assembly, wherein the portion is a seam area of the at least one battery cell.

In some aspects, the techniques described herein relate to a traction battery pack assembly, including: an enclosure assembly; a cell stack within an interior of the enclosure assembly, the cell stack having one or more battery cells; and a support disposed between the cell stack and an area of the enclosure assembly, the one or more battery cells configured to vent through the support to an area between the support and the enclosure assembly.

In some aspects, the techniques described herein relate to a traction battery pack assembly, wherein the enclosure assembly includes an enclosure cover and an enclosure tray that cooperate to provide an enclosed internal area that houses the cell stack.

In some aspects, the techniques described herein relate to a traction battery pack assembly, wherein the support is a first support that is disposed between the enclosure cover and the cell stack, and further including a second support that is disposed between the enclosure tray and the cell stack.

In some aspects, the techniques described herein relate to a traction battery pack assembly, wherein the support includes a plurality of apertures, each of the apertures in the plurality of apertures receiving a portion of at least one battery cell within the one or more battery cells.

In some aspects, the techniques described herein relate to a traction battery pack assembly, wherein the support supports the cell stack at a position spaced from the enclosure assembly to establish at least one immersion coolant channel between the one or more battery cells and the enclosure assembly.

In some aspects, the techniques described herein relate to a traction battery pack assembly, further including a liquid coolant within the at least one immersion coolant channel.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 illustrates a section view at line 3–3 in FIG. 2 showing a cell stack of the battery pack within an enclosure and between first and second cell supports of the battery pack according to an exemplary aspect of the present disclosure.

FIG. 4 illustrates a close-up view of an area of FIG. 3 during a venting event.

FIG. 5 illustrates an expanded, perspective view of a battery cell from battery pack of FIG. 3 along with portions of the first and second cell supports.

FIG. 6 illustrates the perspective view of the battery cell and first and second cell supports of FIG. 5 when assembled, and with optional side plates added.

FIG. 7 illustrates a close-up view of an area of a battery pack having a cell support according to another exemplary aspect of the present disclosure.

### DETAILED DESCRIPTION

An immersion thermal management system can be used to manage thermal energy in a traction battery pack. The immersion thermal management system immerses at least some components, such as battery cells, of the traction battery pack in a liquid coolant. This disclosure is directed toward supporting areas of a battery pack having an immersion thermal management system.

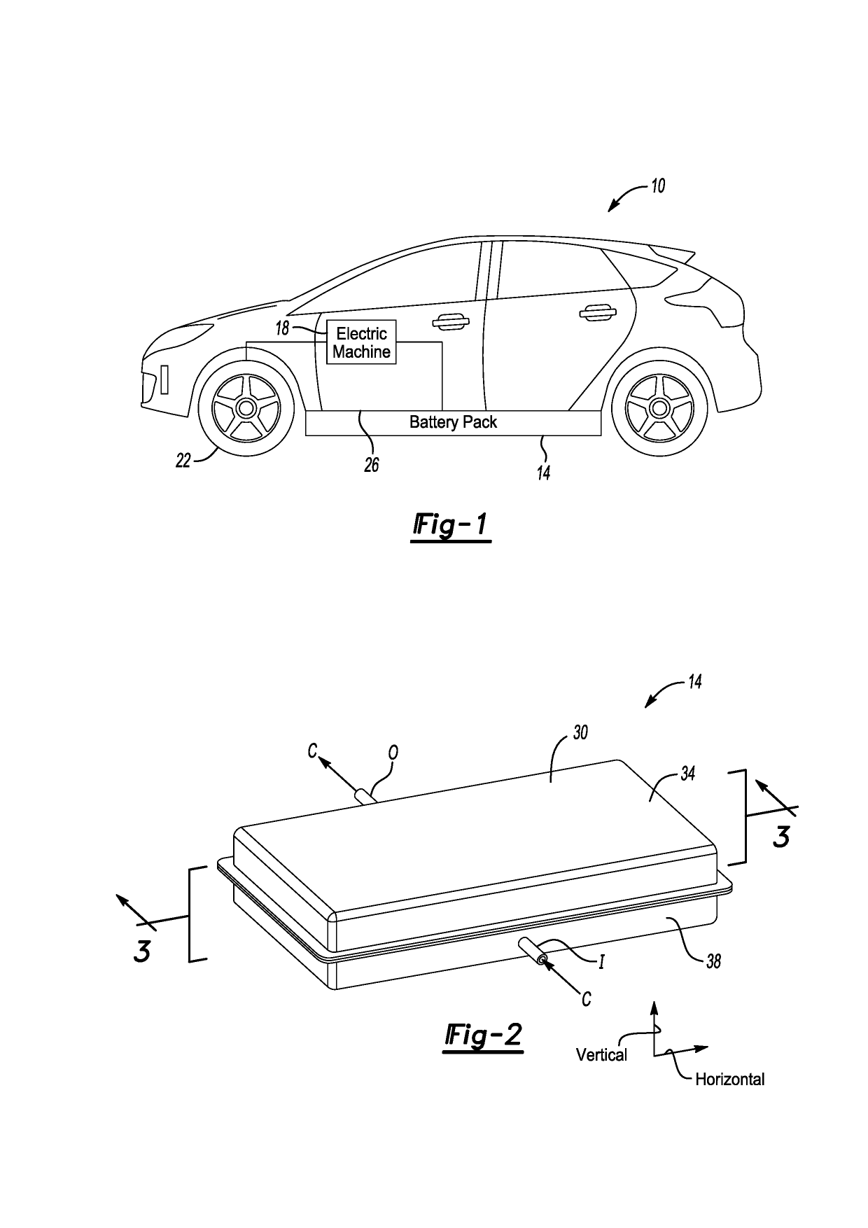

With reference to FIG. 1, an electrified vehicle 10 includes a traction battery pack 14, an electric machine 18, and wheels 22. The traction battery pack 14 powers the electric machine 18, which can convert electrical power to mechanical power to drive the wheels 22.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

The traction battery pack 14 is, in the exemplary embodiment, secured to an underbody 26 of the electrified vehicle 10. The traction battery pack 14 could be located elsewhere on the electrified vehicle 10 in other examples.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

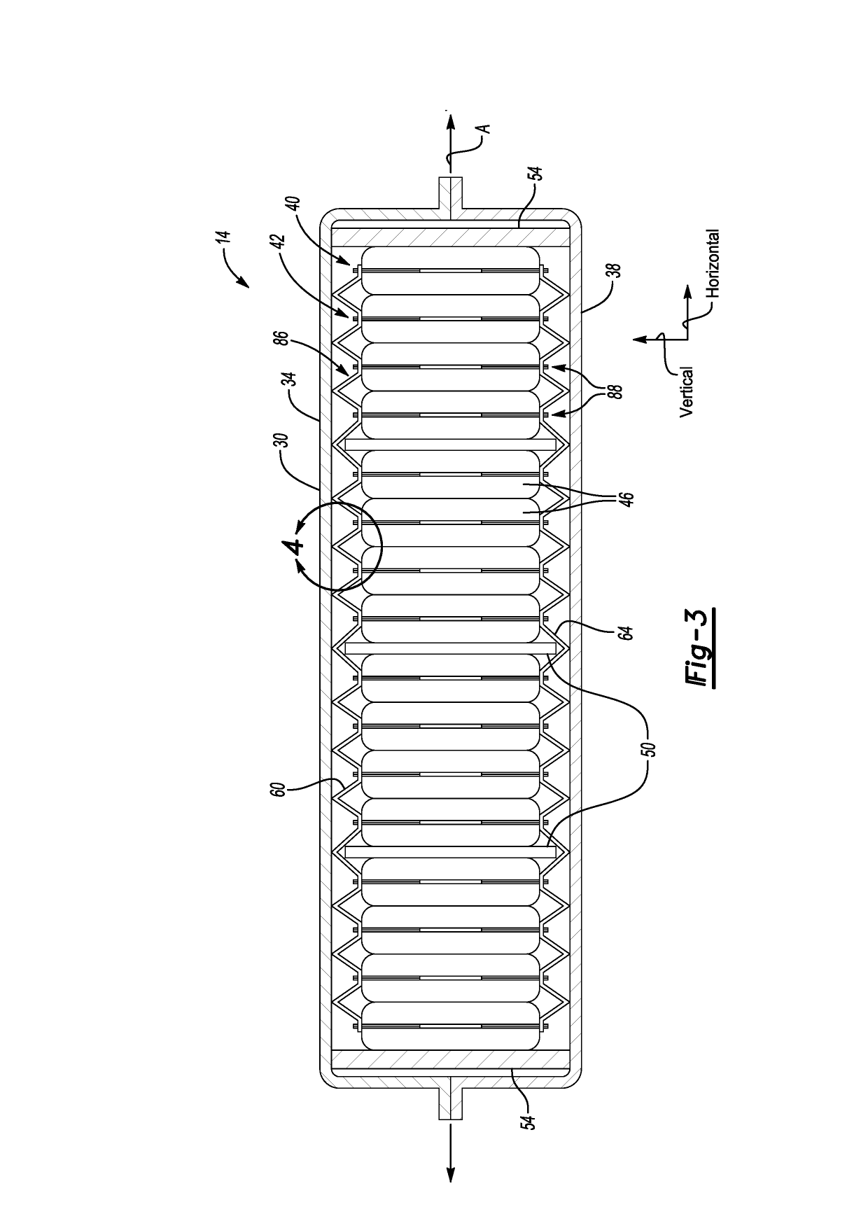

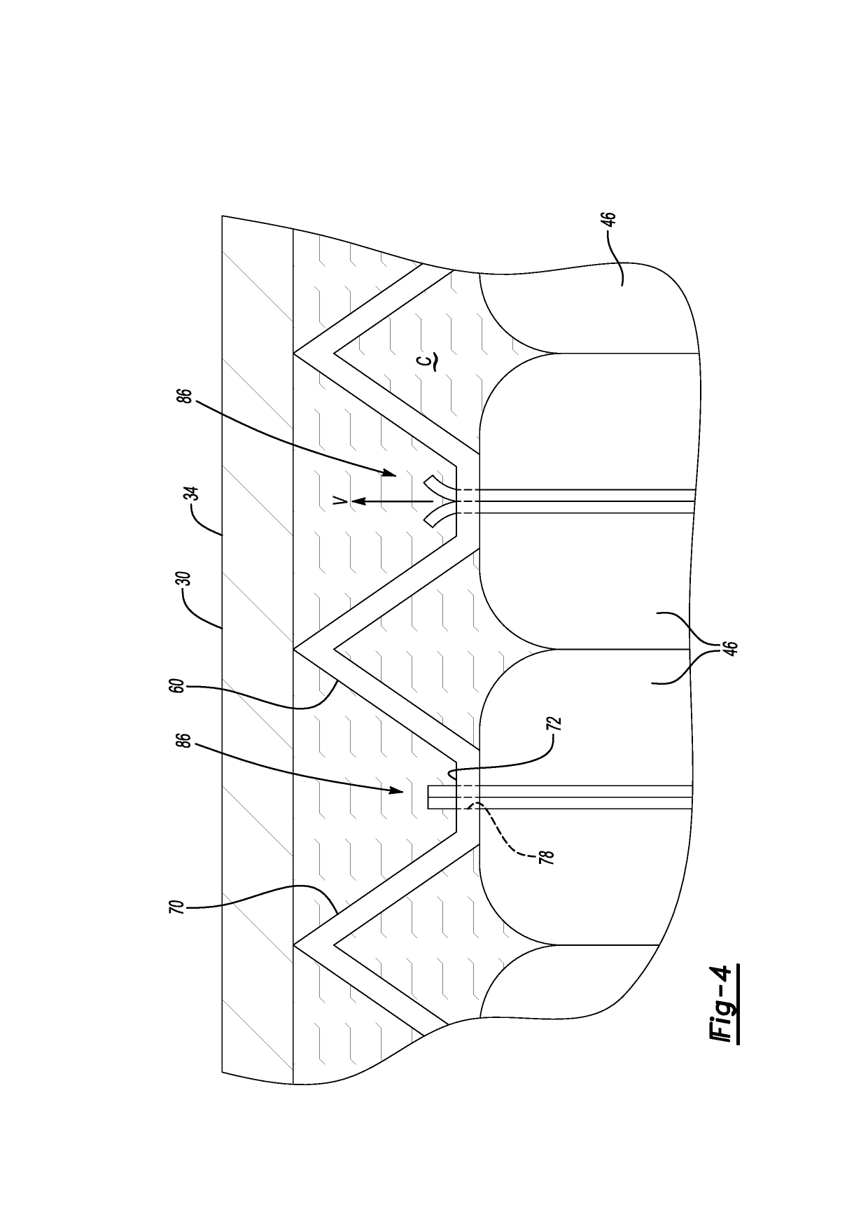

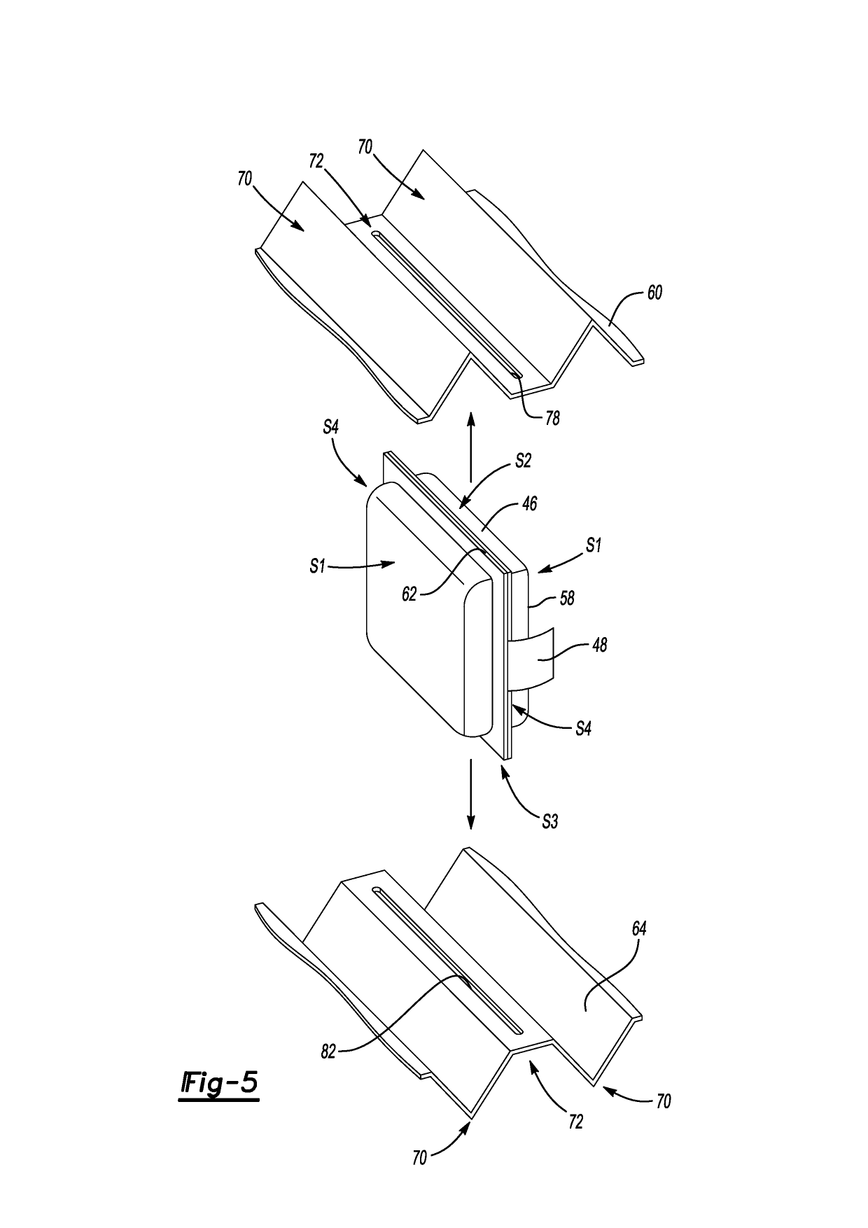

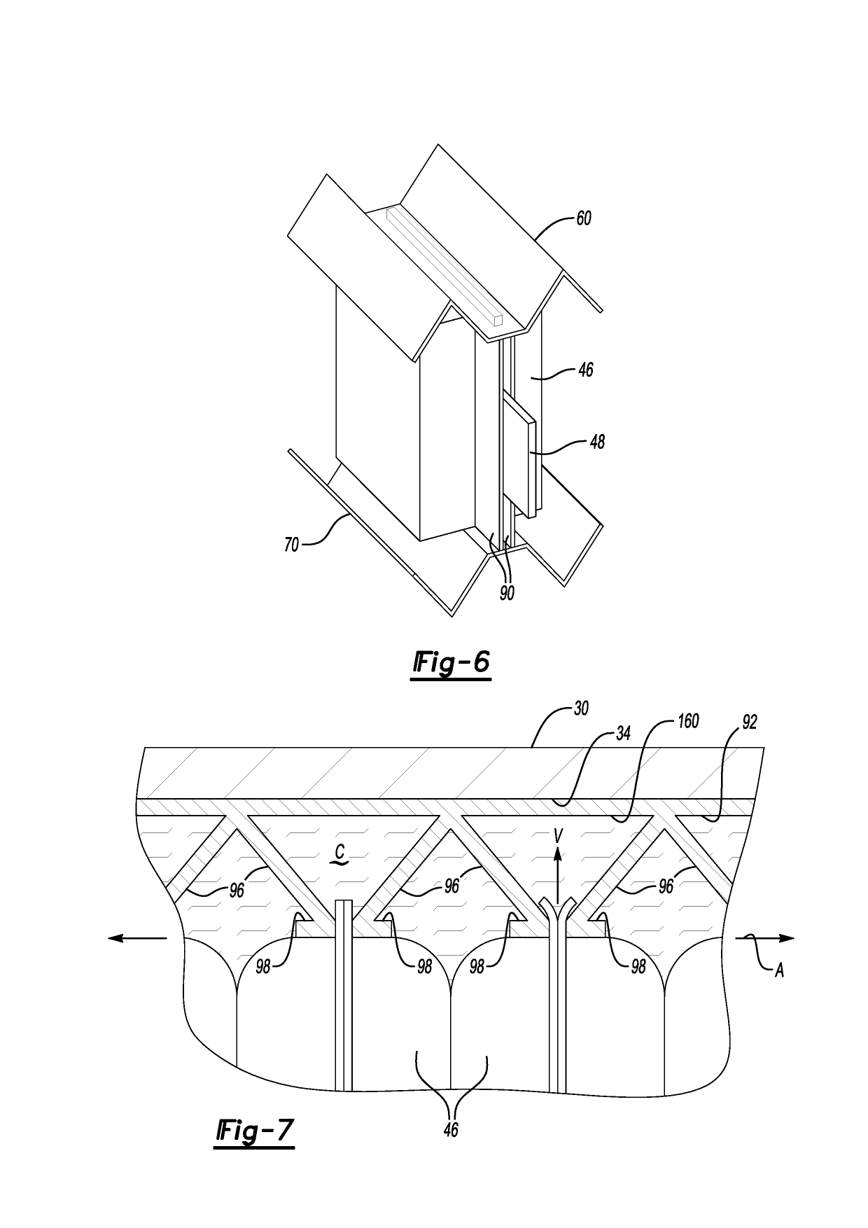

Referring now to FIGS. 2–6, the battery pack 14 includes an enclosure assembly 30 having a cover 34 and a tray 38. The cover 34, in this example, is vertically above the tray 38. In other examples, however, the cover 34 could be arranged below, or to a side of the tray 38.

Vertical is with reference to ground and a general orientation of the vehicle 10 and the battery pack 14 during operation. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1.

The cover 34 and the tray 38 are polymer-based in this example. In other examples, one or both of the cover 34 and the tray 38 can be a metal, metal alloy, or some other material. The example cover 34 is secured to the tray 38 using adhesive and mechanical fasteners in one example of this disclosure. The cover 34 and tray 38 could be connected using other fluid-tight connection techniques in other examples. Further, while an exemplary enclosure assembly 30 is shown in the drawings, the enclosure assembly 30 may vary in size, shape, and configuration within the scope of this disclosure. The cover 34, for example, could include multiple separate pieces that, when combined, provide the cover 34.

In this disclosure, the traction battery pack 14 includes at least one cell stack 42 having one or more individual battery cells 46 disposed along a cell stack axis A. The cover 34 and the tray 38 cooperate to provide an enclosed interior area 40 that houses the cell stack 42.

The cell stack 42 could include any number of battery cells 46. The battery pack 14 could also employ any number of cell stacks 42 within the enclosure assembly 30. Thus, this disclosure is not limited to the exact configuration shown. Further, while the battery cells 46 of the exemplary embodiment are positioned side-by-side relative to one another along the cell stack axis A, other configurations are also contemplated within the scope of this disclosure, including but not limited to embodiments in which the battery cells 46 are stacked on top of one another, for example.

The cell stack 42 is arranged in the interior area 40 of the enclosure assembly 30 between the tray 38 and the cover 34. During operation, a thermal management system can route non-conductive (i.e., dielectric) coolant C through the interior area 40 over areas of the cell stack 42 to manage thermal energy within the cell stack 42. The coolant C can, for example, take on heat from the cell stack 42 to cool the cell stack 42.

The thermal management system is an immersion thermal management system at least because portions of the battery pack 14, here at least the battery cells 46 of the cell stack 42 are immersed in the coolant C.

The coolant C is a dielectric fluid in this example. The coolant can be an oil. The coolant can be non-conductive and can be a liquid that is designed for immersion cooling of the battery cells 46 and other components. The chemical makeup and design characteristics (e.g., dielectric constant, maximum breakdown strength, boiling point, etc.) of the coolant C can vary depending on the environment that the battery pack 14 is designed to be utilized in. Unlike some conductive glycol coolants utilized within cold plate cooling systems, the coolant C of the exemplary embodiment is designed for immersion cooling and allows for direct contact with the battery cells 46 and other electrified components.

The coolant C can enter the interior area 40 of the enclosure assembly 30 through an inlet I and impinge on the battery cells 46. Some of the coolant C moves vertically upward and then moves over a vertical top of the cell stack 42. Some of the coolant C moves vertically downward and then moves beneath the cell stack 42. After moving over or under the cell stack 42 the coolant can exit the interior area 40 through an outlet O.

In an example, the coolant C takes on thermal energy from components within the interior of the enclosure assembly 30 and is then routed to, for example, a heat exchanger outside the battery pack 14. At the heat exchanger, thermal energy is release from the coolant C. The coolant C is then recirculated back through the interior area 40.

The cell stack 42 further includes a plurality of dividers 50 and a pair of endplates 54. The dividers 50 can be foam, a thermal barrier, or a combination of both. The dividers 50 are disposed axially between groups of the battery cells 46 along the cell stack axis A. The dividers 50 and the battery cells 46 are sandwiched between the endplates 54 along the cell stack axis A.

Within the interior area 40, the battery pack 14 further includes a first corrugated support 60 and a second corrugated support 64 that can help to support and position the cell stack 42. In the exemplary embodiment, the first corrugated support 60 is vertically above the cell stack 42 and spans between the cell stack 42 and the cover 34. The second corrugated support 64 is vertically beneath the cell stack 42 and spans between the cell stack 42 and the tray 38. The battery pack 14, in another example, could include one corrugated support or more than two corrugated supports. The first corrugated support 60 and the second corrugated support 64 are exemplary types of battery cell supports used within the battery pack 14.

The first corrugated support 60 and the second corrugated support 64 each include a plurality of corrugations 70 connected by platform portions 72. The first corrugated support 60 and the second corrugated support 64 are, in this example, a metal or metal alloy material. The first corrugated support 60 and the second corrugated support 64 can be stamped corrugated supports. A person having skill in this art would understand how to structurally distinguish a stamped component from a component that is not stamped. Thus, describing corrugated supports as stamped corrugated supports implicates structure to the corrugated supports.

The battery cells 46 each have opposing axially facing sides S1, a top side S2, a bottom side S3, and opposing laterally facing sides S4. The axially facing sides S1 can be considered broad sides of the battery cells 46 as these sides are broader than the top sides S2, the bottom sides S3, or the laterally facing sides S4. In an installed position, the top sides S2 of the battery cells 46 face vertically upward from the cell stack axis A, and the bottom sides S3 of the battery cells 46 face downward away from the cell stack axis A. Terminals 48 extend through the laterally facing sides S4 in this example.

In an embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The example battery cells 46 include an outer case 58 having a first section and a second section that are joined at a seam 62 to enclose an electrode structure.

From time to time, pressure and thermal energy levels within one or more of the battery cells 46 can increase. The pressure and thermal energy increase can be due to an overcharge condition, for example. The pressure and thermal energy increase can cause and area of the battery cell 46 to rupture. Vent byproducts V, such as gas and debris, are then expelled from within the interior of the battery cell 46 relieving the pressure differential.

The vent byproducts V are released from within the battery cell 46 through a vent, which can be a ruptured area within the seam 62. In another example, the vent can include an area of the case 58 having a membrane that yields response to increased internal pressure within the battery cell 46.

The battery cells 46 can be designed so that the battery cells 46 are more likely to vent through the top sides S2 or bottom sides S3, than through the laterally facing sides S4 or axially facing sides S1. The seam 62 along the laterally facing sides S4 can be made stronger than the seam 62 along the top sides S2 or bottom sides S3, which can encourage venting through the top sides S2 and the bottom sides S3 rather than the laterally facing sides S4 of the battery cells 46.

In this example, the platform portions 72 of the first corrugated support 60 interface with the top sides S2 of the battery cells 46. Each of the platform portions 72 includes an aperture 78 that receives a portion of one or more of the battery cells 46. In this example, the apertures 78 receive the seam area of the battery cells 46. Thus, when one or more of the battery cells 46 vent though the top sides S2, the vent byproducts V pass through the aperture 78 to an area between the first corrugated support 60 and the enclosure cover 34.

In this example, the platform portions 72 of the second corrugated support 64 interface with the bottom sides S3 of the battery cells 46. Each of the platform portions 72 of the second corrugated support 64 includes an aperture 82 that receives a portion of one or more of the battery cells 46. In this example, the apertures 82 receive the seam area along the bottom sides S3 of the battery cells 46. Thus, when one or more of the battery cells 46 vent though the bottom sides S3, the vent byproducts V pass through the aperture 82 to an area between the second corrugated support 64 and the enclosure tray 38.

The vent byproducts V can have a relatively high thermal energy level. After vent byproducts V pass through one of the apertures 78 and are discharged from the battery cell 46, the vent byproducts V move into the coolant C. The first corrugated support 60 can block the coolant C with the vent byproducts V from moving axially adjacent to other battery cells 46 that are not venting. Instead, the coolant C with the vent byproducts V is directly laterally outward. The coolant C with the vent byproducts V can then be communicated outside the enclosure assembly 30.

Similarly, after vent byproducts V pass through one of the apertures 82, the second corrugated support 64 can direct coolant C with the vent byproducts V laterally outward rather than permitting the coolant C with the vent byproducts V from moving axially adjacent to other battery cells 46 that are not venting.

The first corrugated support 60 and the second corrugated support 64 support the cell stack 42, at a position spaced from the enclosure assembly 30 (i.e., spaced from the enclosure cover 34 and the enclosure tray 38). The first corrugated support 60 establishes channels 86 for communicating the coolant C over the top sides S2 of battery cells 46 of the cell stack 42. The apertures 78 open to alternating channels 86 along the axis A such that every other channel 86 can receive vent byproducts V from one or more of the battery cells 46.

The second corrugated support 64 establishes channels 88 for communicated the coolant C over the bottom sides S3 of the battery cells 46. The apertures 82 open to alternating channels 88 along the axis A such that every other channel 88 can receive vent byproducts V from one or more of the battery cells 46.

At a position laterally outside the battery cells 46, the battery pack 14 can optionally include side plates 90 that are used to fluidly couple the channels 86 to the channels 88. The side plates 90 can block flow of coolant C axially at positions laterally outside the cell stack 42. The side plates 90 can be spaced laterally from the enclosure assembly 30 so that, during ordinary operation, coolant C delivered through the inlet I can move axially along the cell stack 42 before moving upward or downward.

In this example, the platform portions 72 interface directly with the battery cells 46 of the cell stack 42. The platform portions 72 can directly contact the battery cells 46, can be bonded to the battery cells 46 using an adhesive thermal interface material, or some combination of these. The platform portions 72 each interface directly with one battery cell 46 in this example. That is, each platform portions 72 of the first corrugated support 60 interfaces directly with the top sides S2 of one of the battery cells 46 of the cell stack 42, and each platform portions 72 of the second corrugated support 64 interfaces directly with the bottom sides S3 of one of battery cells 46 of the cell stack 42.

With reference now to FIG. 7, a battery pack, according to another example embodiment includes at least one battery cell support 160 used to support the cells 46 of the cell stack 42 at a position spaced from the enclosure cover 34 of the enclosure assembly 30. The cells 46 can vent through the support 160 into an area between a portion of the support 160 and the enclosure cover 34. The area include the coolant C.

The support 160 includes a base 92 and a plurality of legs 96 that span from the base 92 to the cells 46. A lip 98 can extend transversely from an end of the legs 96 opposite the base 92. The lip 98 can facilitate good contact between the support 160 and the cells 46.

In some designs, the support 160 can help to constrain the cells 46 horizontally and vertically. If, for example, the lips 98 interface with an angled surface of the cells 46.

During a venting event, the legs 96 block movement of the coolant C with the vent byproducts V along the axis A. Instead, the coolant C with the vent byproducts V is directed laterally outward away from the cell stack axis A. The support 160 can be used in a battery pack having another support vertically beneath the cells 46. That other support can include legs extending from a base to contact the bottom sides of the cells 46.

Features of the disclosed examples include battery cell stands that help to support battery cells within a traction battery pack while, during a venting event, directing vent byproducts away from battery cells that are not venting. In some examples, each cell can be supported on opposing sides of seam, which can help to stabilize the battery cells within the battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly;
a cell stack within an interior of the enclosure assembly, the cell stack having one or more battery cells; and
a corrugated support spanning between the cell stack and an area of the enclosure assembly, the corrugated support supporting the cell stack at a position spaced from the enclosure assembly, the one or more battery cells configured to vent to an area between the corrugated support and the enclosure assembly.

2. The traction battery pack assembly of claim 1, wherein the corrugated support is a metal or a metal alloy.

3. The traction battery pack assembly of claim 1, wherein the corrugated support supports the cell stack.

4. The traction battery pack assembly of claim 3, wherein the corrugated support supports the cell stack at a position spaced from the enclosure assembly to establishes at least one immersion coolant channel between the one or more battery cells and the enclosure assembly.

5. The traction battery pack assembly of claim 4, further comprising a liquid coolant within the at least one immersion coolant channel.

6. The traction battery pack assembly of claim 1, wherein the one or more battery cells are one or more pouch-style battery cells.

7. The traction battery pack assembly of claim 1, wherein the corrugated support is a first corrugated support that is above the cell stack, and further comprising a second corrugated support that is beneath the cell stack.

8. The traction battery pack assembly of claim 1, wherein the corrugated support directly contacts the one or more battery cells of the cell stack.

9. The traction battery pack assembly of claim 1, wherein the corrugated support includes a plurality of apertures, each of the apertures in the plurality of apertures receiving a portion of at least one battery cell within the one or more battery cells.

10. The traction battery pack assembly of claim 9, wherein the portion is a seam area of the at least one battery cell.

11. A traction battery pack assembly, comprising:
an enclosure assembly;
a cell stack within an interior of the enclosure assembly, the cell stack having one or more battery cells; and
a support disposed between the cell stack and an area of the enclosure assembly, the one or more battery cells configured to vent through the support to an area between the support and the enclosure assembly.

12. The traction battery pack assembly of claim 11, wherein the enclosure assembly includes an enclosure cover and an enclosure tray that cooperate to provide an enclosed internal area that houses the cell stack.

13. The traction battery pack assembly of claim 12, wherein the support is a first support that is disposed between the enclosure cover and the cell stack, and further comprising a second support that is disposed between the enclosure tray and the cell stack.

14. The traction battery pack assembly of claim 11, wherein the support includes a plurality of apertures, each of the apertures in the plurality of apertures receiving a portion of at least one battery cell within the one or more battery cells.

15. The traction battery pack assembly of claim 11, wherein the support supports the cell stack at a position spaced from the enclosure assembly to establish at least one immersion coolant channel between the one or more battery cells and the enclosure assembly.

16. The traction battery pack assembly of claim 15, further comprising a liquid coolant within the at least one immersion coolant channel.
